(19) United States
(12) Patent Application Publication
(10) Pub. No.: US 2021/0157534 A1
(43) Pub. Date: May 27, 2021

(54) PRINTING CONTENT BASED ON PRINTING MEDIUM GEOMETRY

(71) Applicant: HEWLETT-PACKARD DEVELOPMENT COMPANY, L.P., Spring, TX (US)

(72) Inventor: Chung-Min Tsai, Taipei City (TW)

(73) Assignee: HEWLETT-PACKARD DEVELOPMENT COMPANY, L.P., Spring, TX (US)

(21) Appl. No.: 17/046,891

(22) PCT Filed: May 18, 2018
(86) PCT No.: PCT/US2018/033289

§ 371 Date: Oct. 12, 2020

(51) Int. Cl. G06F 3/12

(52) U.S. Cl. CPC G06F 3/1219; G06F 3/1204; G06F 3/1285; G06F 3/1256; G06F 3/125

(57) ABSTRACT

In one example, a multifunction printing device is described, which may include a scanning unit to scan a printing medium, a detection unit to determine geometry data of the printing medium based on the scanning, and an execution unit to execute a print job or a copy job to print content on the printing medium based on the geometry data of the printing medium.

### BACKGROUND

Printers may be connected to computing systems through wired or wireless networks, such as a local area network (LAN) or a wide area network (WAN). Different kinds of printers such as inkjet printers and laser printers are commercially available. Such printers, also referred to as multifunction printing devices, may provide the functionalities of a scanner as well as that of a copier, a printer, a fax, and the like. For example, the multifunction printing devices may facilitate a user to scan, print, and copy documents from a single device.

### BRIEF DESCRIPTION OF THE DRAWINGS

Examples are described in the following detailed description and in reference to the drawings, in which:

FIG. 1A is a block diagram of an example multifunction printing device including components to print content on a printing medium based on geometry data of the printing medium;

FIGS. 1B and 1C are block diagram of the example multifunction printing device of FIG. 1A, depicting additional features;

FIG. 2A is a block diagram of an example client device communicatively connected to a multifunction printing device to print content on a printing medium based on geometry data of the printing medium;

FIG. 2B is a block diagram of the example client device of FIG. 2A, depicting additional features;

FIG. 3 is an example schematic diagram illustrating a sequence of a process for printing content on a partial printing medium based on geometry data of the partial printing medium;

FIG. 4 is an example method for printing content on a printing medium based on geometry data of the printing medium; and

FIG. 5 is a block diagram of an example multifunction printing device including a non-transitory machine-readable storage medium, storing instructions to print content on a printing medium based on geometry data of the printing medium.

### DETAILED DESCRIPTION

Multifunction printing devices may facilitate a user to scan and print documents from a single device. The multifunction printing devices may facilitate performing multiple jobs at one command. For example, a user may provide a command to scan a document and subsequently print the same document. However, there may be instances that the printed document may include less content, for instance, 20% of the printing medium. In such scenarios, the remaining portion of the printing medium may be blank. This may lead to wastage of the printing medium such as a sheet of paper on which the content is printed. At times, the user may have less content to be printed and the user may try to reuse the printed document. In such scenarios, a user may cut the printed document to a specific size/shape (e.g., referred to as a partial printing medium) and manually adjust the content onto the partial printing medium for reusing the partial printing medium. To re-use the partial printing medium, the user may have to align the content on the blank space of the partial printing medium before giving a print command. This may be a cumbersome task for the user.

Examples described herein may provide a multifunction printing device capable of providing printing and scanning functionalities. The multifunction printing device may facilitate a user to print content on a partial printing medium such as a cut sheet of paper. In one example, the multifunction printing device may scan the partial printing medium to determine partial printing medium information (e.g., geometry data) such as a size and a shape of the printing medium. Further, the multifunction printing device may receive, based on user instructions, content to be printed on the partial printing medium and automatically control an alignment of the content on the partial printing medium based on the partial printing medium information. Then, the multifunction printing device may execute a print job or a copy job to print the content on the partial printing medium based on alignment of the content.

Thus, examples described herein may facilitate in utilizing the cut sheets of paper for printing content thereon, thereby reducing wastage of papers and saving paper cost and usage.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

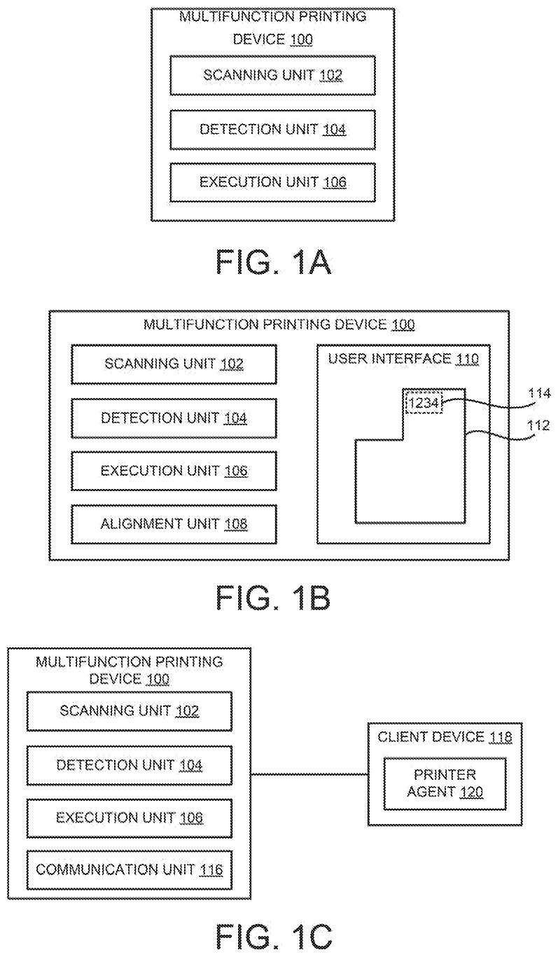

Turning now to figures, FIG. 1A is a block diagram of an example multifunction printing device 100 including components to print content on a printing medium based on geometry data of the printing medium. In one example, multifunction printing device 100 may be implemented as a commercially available printer including the functionalities of a scanner along with that of a copier, a printer, a fax, and/or the like. Example multifunction printing device 100 may be a printer-scanner, a printer-scanner-copier-fax, or the like.

Example multifunction printing device 100 may include a scanning unit 102, a detection unit 104, and an execution unit 106. Example scanning unit 102 may be a built-in scanner to scan printing mediums (e.g., papers). In one example, the components of multifunction printing device 100 may be implemented in hardware, machine-readable instructions, or a combination thereof. For example, detection unit 104 and execution unit 106 may be implemented as engines or modules comprising any combination of hardware and programming to implement the functionalities described herein.

During operation, scanning unit 102 may scan a printing medium. In one example, the printing medium may refer to a partial printing medium such as a cut sheet of paper. The terms “printing medium” and “partial printing medium” are used interchangeably throughout the document. Detection unit 104 may determine geometry data of the printing medium based on the scanning. Example geometry data may correspond to a size and a shape of the printing medium.

Further, execution unit 106 may execute a print job or a copy job to print content on the printing medium based on the geometry data of the printing medium. In one example, execution unit 106 may execute the print job to print content onto the printing medium via a printer function of multifunction printing device 100 and execute the copy job to copy the content of a copy target via a copy function of multifunction printing device 100.

FIGS. 1B and 1C are block diagrams of example multifunction printing device 100 of FIG. 1A, depicting additional features. For example, similarly named elements of FIGS. 1B and 1C may be similar in structure and/or function to elements described with respect to FIG. 1A.

As shown in FIG. 1B, multifunction printing device 100 may include an alignment unit 108 to determine an alignment of the content with respect to the printing medium based on the geometry data. In one example, alignment unit 108 may identify a size and a shape of the printing medium based on the geometry data and align the content to fit within the identified size and shape of the printing medium. In this example, execution unit 106 may print the content on the printing medium based on the determined alignment.

Further as shown in FIG. 11, multifunction printing device 100 may include a user interface 110 (e.g., a display screen) to display a scanned printing medium 112 based on the geometry data. Further, alignment unit 108 may dynamically align content 114 with respect to scanned printing medium 112 based on the geometry data. Furthermore, alignment unit 108 may display the aligned content 114 on user interface 110. For example, alignment unit 108 may automatically change the alignment of content 114 based on a size and shape of scanned printing medium 112. Accordingly, alignment unit 108 may facilitate in positioning content 114 on scanned printing medium 112 based on the geometry data and the user instructions. In other examples, multifunction printing device 100 may also enable the user to specify orientation of content 114 to be printed on the printing medium based on the geometry data. For example, a user can trigger a command (i.e., a copy job) on multifunction printing device 100 via user interface 110 (e.g., a control panel) to copy content on the printing medium. In this example, execution unit 106 may execute the copy job received via user interface 110 to print/copy the content on the printing medium based on the geometry data.

In another example, multifunction printing device 100 may include a read-slot to receive a memory card, in which electronic documents to-be-printed are stored. Upon accessing the memory card, the electronic documents stored on the memory card may be aligned with scanned printing medium 112 and previewed on a user interface 110 (e.g., the display screen) of multifunction printing device 100. Furthermore, a print job associated with the previewed documents may be triggered through the control panel of multifunction printing device 100.

For example, the memory card accessible to multifunction printing device 100 may include, but not limited to, an SD™ card (Secure Digital card), a CompactFlash I™ card, a CompactFlash IIM card, a SmartMedia™ card, a Memory Stick™, Memory Stick Duo™, a Memory Stick Micro M2™, a Multi Media card, a MMCmicro™ card, a RS-MMC Card™, a microSD™ card, a miniSD™, a MMCMobile™ card, XD-Picture Card™, a CompactFlash™, or flash drives having a USB interface.

As shown in FIG. 1C, multifunction printing device 100 may include a communication unit 116 to send the geometry data to a client device 118 via a printer agent 120 residing in client device 118. In some examples, multifunction printing device 100 can be communicatively coupled to a plurality of client devices via network(s).

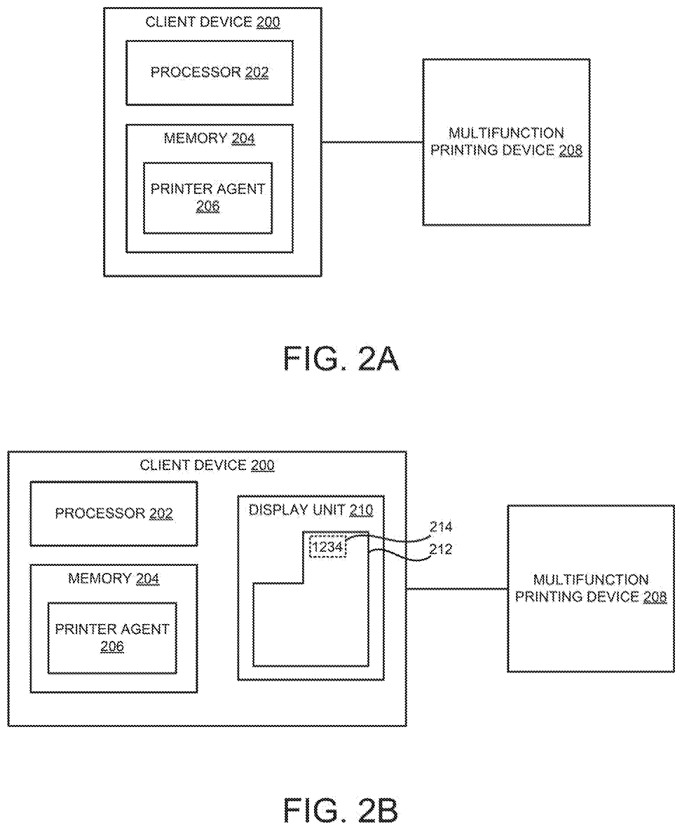

Further, printer agent 120 may align the content with respect to the partial printing medium based on the geometry data and display the aligned content on a display of client device 118. This is explained in FIG. 2B. In some examples, printer agent 120 may facilitate in positioning the content on the partial printing medium based on the geometry data and the user instructions. For example, a user can input new data and send a command (i.e., a print job) to multifunction printing device 100 to print the new data on the partial printing medium. In this example, execution unit 106 may execute the print job received via printer agent 120 to print the new data on the partial printing medium based on the geometry data.

Multifunction printing device 100 may include computer-readable storage medium comprising (e.g., encoded with) instructions executable by a processor to implement functionalities described herein in relation to FIGS. 1A-1C. In some examples, the functionalities described herein, in relation to instructions to implement functions of components of multifunction printing device 100 and any additional instructions described herein in relation to the storage medium, may be implemented as engines or modules comprising any combination of hardware and programming to implement the functionalities of the modules or engines described herein. The functions of components of multifunction printing device 100 may also be implemented by a respective processor. In examples described herein, the processor may include, for example, one processor or multiple processors included in a single device or distributed across multiple devices.

FIG. 2A is a block diagram of an example client device 200 communicatively connected to a multifunction printing device 208 to print content on a printing medium based on geometry data of the printing medium. Example client device 200 may be a server, a laptop, a desktop, a mobile device, a personal digital assistant (PDA), a tablet, or the like. Client device 200 may be connected to multifunction printing device 208 through a wired or a wireless network, such as a local area network (LAN) or a wide area network (WAN).

Client device 200 may include a processor 202 and memory 204 coupled to processor 202. Processor 202 may include microprocessors, microcomputers, microcontrollers, digital signal processors, central processing units, state machines, logic circuitries, and/or any other devices that manipulate signals and data based on computer-readable instructions. Among other capabilities, processor 202 may fetch and execute computer-readable instructions stored in memory 204. Functions of the various elements shown in the figures, including any functional blocks labeled as “processor(s)”, may be provided through the use of dedicated hardware as well as hardware capable of executing computer-readable instructions.

Example memory 204 may include volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In one example, memory 204 may include a printer agent 206. Printer agent 206 may be a printer driver that is either installed in or accessible to client device 200 to access multifunction printing device 208.

During operation, printer agent 206 may scan a printing medium using a multifunction printing device 208. In one example, the printing medium may include a geometry different from a default geometry defined by a printing medium tray associated with multifunction printing device 208. For example, the printing medium may be a partial printing medium, such as a cut sheet of paper. Further, printer agent 206 may receive geometry data of the printing medium from multifunction printing device 208 based on the scanning. Example geometry data may correspond to a size and a shape of the printing medium.

Furthermore, printer agent 206 may receive, based on user instructions, content to be printed on the printing medium. Also, printer agent 206 may align the content on the printing medium based on the geometry data. In another example, printer agent 206 may facilitate in positioning the content on the partial printing medium based on the geometry data and the user instructions. In other examples, printer agent 206 may also enable the user to specify orientation of the content to be printed on the printing medium based on the geometry data. Then, printer agent 206 may send a print job to multifunction printing device 208 to print the content on the printing medium based on the alignment.

FIG. 2B is a block diagram of example client device 200 of FIG. 2A, depicting additional features. For example, similarly named elements of FIG. 2B may be similar in structure and/or function to elements described with respect to FIG. 2A.

Client device 200 may include a display unit 210 (e.g., touch-screen display). Example display unit 210 may include liquid crystal display (LCD), light emitting diode (LED), electro-luminescent (EL) display, or the like. In one example, printer agent 206 may display the geometry data of the printing medium (e.g., scanned printing medium 212) and aligned content 214 on scanned printing medium 212 via display unit 210. Then, printer agent 206 may send the print job to multifunction printing device 208 to print content 214 on the printing medium based on user instructions.

Client device 200 may include computer-readable storage medium (e.g., memory 204) comprising (e.g., encoded with) instructions executable by processor 202 to implement functionalities described herein in relation to FIGS. 2A and 2B. In some examples, the functionalities described herein, in relation to instructions to implement functions of components of client device 200 and any additional instructions described herein in relation to the storage medium, may be implemented as engines or modules comprising any combination of hardware and programming to implement the functionalities of the modules or engines described herein. The functions of components of client device 200 may also be implemented by a respective processor. In examples described herein, processor 202 may include, for example, one processor or multiple processors included in a single device or distributed across multiple devices.

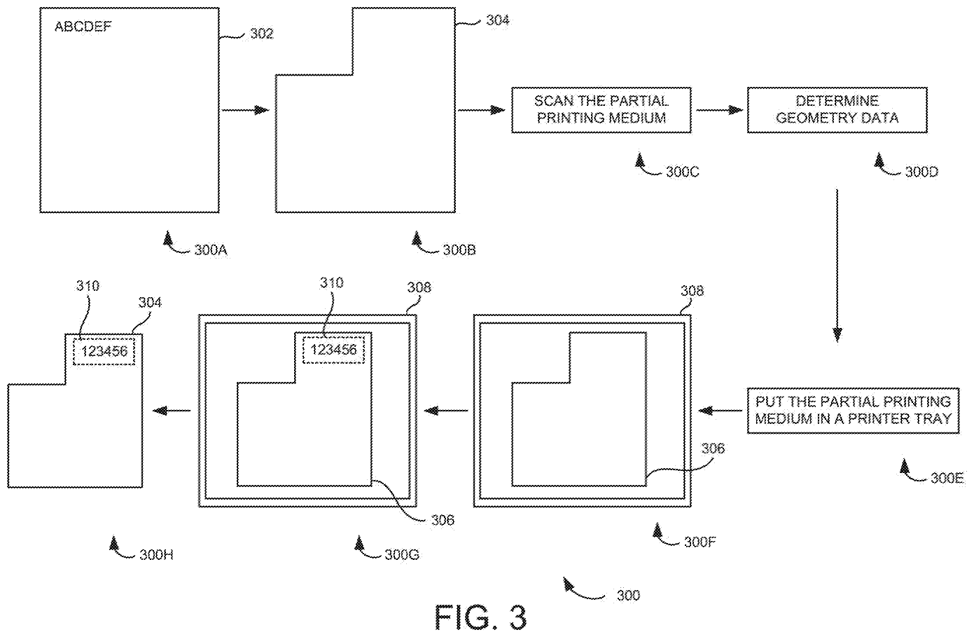

FIG. 3 is an example schematic diagram 300 illustrating a sequence of a process for printing content on a partial printing medium 304 based on geometry data of partial printing medium 304. At 300A, a printing medium 302 with content printed thereon may be provided. In this example, consider that the content may be printed on a portion of printing medium 302, for instance, 20% of printing medium 302. The remaining portion of printing medium 302 may be blank.

At 300B, printing medium 302 having the printed content may be cut to separate the portion of printing medium 302 from the remaining blank portion. The remaining blank portion of printing medium 302 having a specific size and a shape can be herein referred to as a partial printing medium 304. In one example, partial printing medium 304 can be reused for printing the content.

To reuse partial printing medium 304, at 300C, partial printing medium 304 can be placed in a scanning unit of a multifunction printing device and scanned using the scanning unit. At 300D, geometry data (e.g., a size and a shape) of partial printing medium 304 may be determined based on scanning. In one example, the geometry data may be stored in memory (e.g., an in-built memory or a cloud database) associated with the multifunction printing device. In another example, the geometry data may also be stored in memory associated with a client device (e.g., that is used for scanning partial printing medium 304).

In some examples, the stored geometry data may be assigned a document identifier and referred at a later point in time for printing the content. The document identifier may facilitate a user to identify a correct geometry data of the scanned document in future. At 300E, partial printing medium 304 may be fed to a printer tray associated with the multifunction printing device. At 300F, scanned printing medium 306 may be displayed on a display unit 308 associated with the multifunction printing device or the client device (e.g., via a printer agent), for instance, using the geometry data and the document identifier.

At 300G, new data 310 to be printed on partial printing medium 304 may be received, for instance, from a user. As shown in 300G, new content 310 may be aligned to fit within scanned printing medium 306 based on the geometry data and the aligned content may be displayed on display unit 308. Then, a user may be prompted to print new data 310 on partial printing medium 304. Further, a command may be sent to the multifunction printing device to print new data 310 within the geometry data of partial printing medium 304. As shown in 300H, new data 310 may be printed on partial printing medium 304. Similarly, content can be copied onto partial printing medium 304 by triggering a copy job via the multifunction printing device. Thus, partial printing medium 304 can be reused for printing/copying the content.

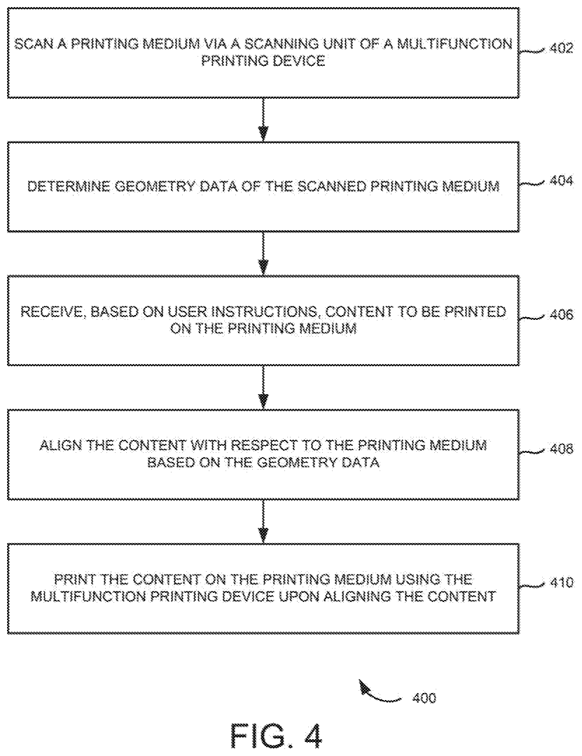

FIG. 4 is an example method 400 for printing content on a printing medium based on geometry data of the printing medium. It should be understood that the process depicted in FIG. 4 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 402, a printing medium (e.g., a cut sheet of paper) may be scanned via a scanning unit of a multifunction printing device. At 404, geometry data of the printing medium may be determined based on the scanning. At 406, content to be printed on the printing medium may be received based on user instructions. At 408, the content may be aligned with respect to the printing medium based on the geometry data. At 410, the content may be printed on the printing medium using the multifunction printing device upon aligning the content.

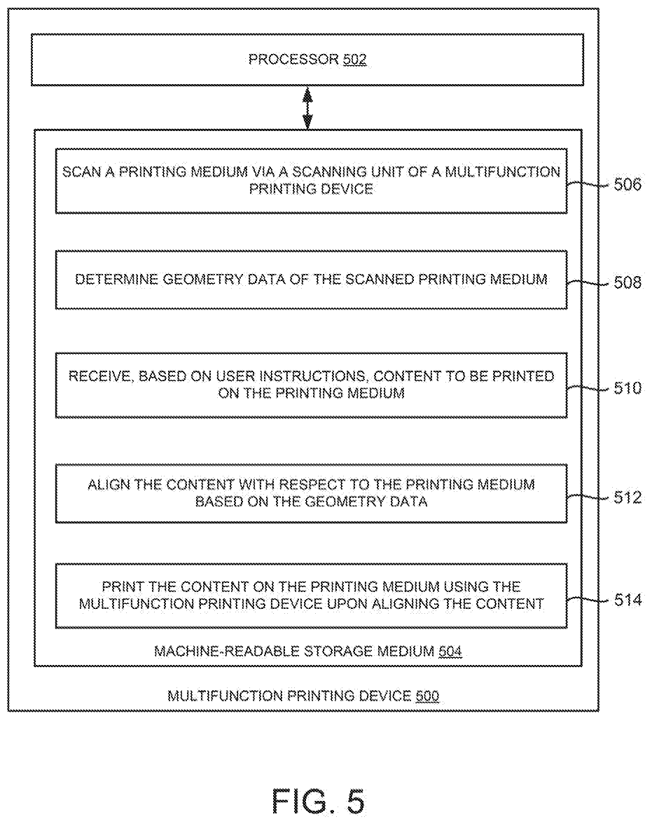

FIG. 5 is a block diagram of an example multifunction printing device 500 including a non-transitory machine-readable storage medium 504, storing instructions (e.g., 506 to 514) to print content on a printing medium based on geometry data of the printing medium.

Multifunction printing device 500 may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 504 may be a non-transitory machine-readable medium. In an example, machine-readable storage medium 504 may be remote but accessible to multifunction printing device 500.

As shown in FIG. 5, machine-readable storage medium 504 may store instructions 506-514. In an example, instructions 506-514 may be executed by processor 502 to reuse a partial printing medium (e.g., a cut sheet of paper) for printing/copying content. Instructions 506 may be executed by processor 502 to scan a printing medium via a scanning unit of multifunction printing device 500.

Instructions 508 may be executed by processor 502 to determine geometry data of the printing medium based on the scanning. Example geometry data corresponds to a size and a shape of the printing medium. Instructions 510 may be executed by processor 502 to receive, based on user instructions, content to be printed on the printing medium.

Instructions 512 may be executed by processor 502 to align the content with respect to the printing medium based on the geometry data. In one example, machine-readable storage medium 504 may store instructions to identify a size and shape of the printing medium based on the geometry data and align the content to fit within the identified size and shape of the printing medium.

Instructions 514 may be executed by processor 502 to print the content on the printing medium (i.e., within the geometry data) using multifunction printing device 500 upon aligning the content. In one example, the geometry data of the printing medium may be displayed on a display of multifunction printing device 500. Further, the aligned content may be displayed on the display of multifunction printing device 500. In this example, a copy job may be received on multifunction printing device 500 to print/copy the aligned content on the printing medium based on the geometry data.

In another example, the geometry data of the printing medium may be outputted on a display of a client device via a printer agent residing in the client device. Further, the aligned content may be displayed on the display of the client device. In this example, a print job may be received via the printer agent to print the aligned content on the printing medium based on the geometry data. Machine-readable storage medium 504 may further store instructions to facilitate in positioning the content on the printing medium based on the geometry data and the user instructions.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A multifunction printing device comprising:
a scanning unit to scan a printing medium;
a detection unit to determine geometry data of the printing medium based on the scanning; and
an execution unit to execute a print job or a copy job to print content on the printing medium based on the geometry data of the printing medium.

2. The multifunction printing device of claim 1, wherein the geometry data corresponds to a size and a shape of the printing medium.

3. The multifunction printing device of claim 1, further comprising an alignment unit to:
determine an alignment of the content with respect to the printing medium based on the geometry data, wherein the execution unit is to print the content on the printing medium based on the determined alignment.

4. The multifunction printing device of claim 1, further comprising:
a user interface to display the geometry data of the printing medium, wherein the execution unit to execute the copy job received via the user interface to print the content on the printing medium based on the geometry data.

5. The multifunction printing device of claim 1, further comprising:
a communication unit to send the geometry data to a client device via a printer agent residing in the client device, wherein the execution unit to execute the print job received via the printer agent to print the content on the printing medium based on the geometry data.

6. A client device comprising:
a processor; and
a memory coupled to the processor, wherein the memory includes a printer agent to:
scan a printing medium using a multifunction printing device;
receive geometry data of the printing medium from the multifunction printing device based on the scanning;
receive, based on user instructions, content to be printed on the printing medium;
align the content on the printing medium based on the geometry data; and
send a print job to the multifunction printing device to print the content on the printing medium based on the alignment.

7. The client device of claim 6, wherein the geometry data corresponds to a size and a shape of the printing medium.

8. The client device of claim 6, further comprising:
a display unit, wherein the printer agent is to display the geometry data of the printing medium and the aligned content on the printing medium via the display unit.

9. The client device of claim 6, wherein the printing medium having a geometry different from a default geometry defined by a printing medium tray associated with the multifunction printing device.

10. A non-transitory machine-readable storage medium encoded with instructions that, when executed by a processor, cause the processor to:
scan a printing medium via a scanning unit of a multifunction printing device;
determine geometry data of the printing medium based on the scanning;
receive, based on user instructions, content to be printed on the printing medium;
align the content with respect to the printing medium based on the geometry data; and
print the content on the printing medium using the multifunction printing device upon aligning the content.

11. The non-transitory machine-readable storage medium of claim 10, wherein the geometry data corresponds to a size and a shape of the printing medium.

12. The non-transitory machine-readable storage medium of claim 10, wherein instructions to align the content with respect to the printing medium comprises:
instructions to identify a size and a shape of the printing medium based on the geometry data; and
instructions to align the content within the identified size and shape of the printing medium.

13. The non-transitory machine-readable storage medium of claim 10, further comprising instructions to:
display the geometry data and the aligned content on a display of the multifunction printing device; and
receive a copy job on the multifunction printing device to print the aligned content on the printing medium based on the geometry data.

14. The non-transitory machine-readable storage medium of claim 10, further comprising instructions to:
output the geometry data and the aligned content on a display of a client device via a printer agent residing in the client device; and
receive a print job via the printer agent to print the aligned content on the printing medium based on the geometry data.

15. The non-transitory machine-readable storage medium of claim 10, further comprising instructions to:
facilitate in positioning the content on the printing medium based on the geometry data and the user instructions.
